(19) United States
(12) Patent Application Publication
(10) Pub. No.: US 2007/0033414 A1
(43) Pub. Date: Feb. 8, 2007

(54) Methods, systems, and computer program products for sharing digital rights management-protected multimedia content using biometric data

(75) Inventor: Gregory A. Dunko, Cary, NC (US)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 11/195,288

(22) Filed: Aug. 2, 2005

(51) Int. Cl. H04K 1/00

(52) U.S. Cl. 713/186

(57) ABSTRACT

Digital multimedia content having a rights object associated therewith may be shared between multiple devices. A first device includes digital multimedia content and an associated rights object therein. Biometric user data is obtained at the first device via a biometric sensor associated therewith and is combined with the rights object to provide a user-specific rights object. The multimedia content and the user-specific rights object are loaded onto a second device. Biometric user data is obtained at the second device via a biometric sensor associated therewith and is combined with the user-specific rights object to provide the rights object at the second device. The digital multimedia content is rendered on the second device using the rights object.

### FIELD OF THE INVENTION

The present invention relates to digital multimedia products, and more specifically, to digital multimedia products that are protected by digital rights management (DRM) technologies.

### BACKGROUND OF THE INVENTION

Digital multimedia products may be widely used for entertainment, education, and/or other purposes. As used herein, the term ‘digital multimedia’ may include digital audio, digital video, and/or digital images which may be embodied in digital multimedia products including, for example, compact discs, digital video discs, video game products, digital television products, memory devices that include digital multimedia files, and/or digital multimedia files that may be distributed over computer networks such as the worldwide web and/or other wireless and/or mobile networks, via satellite, and/or via cable networks.

With the proliferation of digital multimedia products, concerns have been raised by owners of copyright and/or other intellectual property rights in digital multimedia products. These concerns have led to the use and/or proposal of digital rights management (DRM) technologies. DRM provides for secure distribution of digital content. DRM technologies may enable an authorized user of a digital multimedia product use the product, and may include the ability to copy the product under certain circumstances. DRM technologies may also prohibit unauthorized use by the authorized user, such as sending the digital multimedia product by email and/or publishing the digital multimedia on the worldwide web, and may also prohibit use by an unauthorized user.

The basic components of a DRM technology may include the digital multimedia content, which may be transferred between the content provider and a user in a secure fashion, and the rights, which may represent the permissions, obligations, and/or constraints associated with the use of the digital multimedia content. For example, the rights may take the form of a separate “key” that may be required to be available to a multimedia device in order to enable rendering of the digital multimedia content.

Frequently, a user may own and/or use multiple devices that are capable of rendering multimedia content. Such devices may include a combination of portable devices (such as PDAs, mobile phones, media players, etc.) and/or non-portable devices (such as home PCs or home multimedia systems). DRM technologies may allow a user to purchase and/or acquire multimedia content via numerous sources, including CD/DVD purchase, wired internet download to a PC/media server, and/or over-the-air download to a properly equipped wireless device. Accordingly, a user who has purchased digital multimedia content for use with one device may wish to load this content on other devices that he owns and/or uses. However, conventional DRM technologies may require that these other devices be registered, for example, via a security protocol with a rights issuer, in order to use the purchased digital multimedia content on the other devices. As such, loading and/or transferring digital multimedia content between multiple multimedia devices may present difficulties for some multimedia purchasers.

### SUMMARY OF THE INVENTION

According to some embodiments of the present invention, a method of sharing digital multimedia content having a rights object associated therewith between multiple devices includes obtaining biometric user data at a first device. The first device includes multimedia content and an associated rights object therein. The biometric user data is obtained via a biometric sensor associated with the first device. The biometric data obtained at the first device is combined with the rights object to provide a user-specific rights object. The multimedia content and the user-specific rights object are loaded on a second device, and biometric user data is obtained at the second device via a biometric sensor associated therewith. The biometric data obtained at the second device is combined with the user-specific rights object to provide the rights object. For example, the biometric data may be combined with the user-specific rights object if the biometric data obtained at the second device matches the biometric data obtained at the first device. The digital multimedia content is rendered on the second device using the rights object. As such, at least some use of the digital multimedia content may be prevented on the second device if the biometric data obtained at the second device does not match the biometric data obtained at the first device.

In some embodiments, the biometric data obtained at the first device may be combined with the rights object by encrypting the rights object using the biometric data obtained at the first device to provide the user-specific rights object. Likewise, the biometric data obtained at the second device may be combined with the user-specific rights object by decrypting the user-specific rights object using the biometric data obtained at the second device to provide the rights object.

In other embodiments, the rights object may include a content encryption key (CEK) used to encrypt the digital multimedia content. The biometric data obtained at the first device may be combined with the content encryption key (CEK) to provide a user-specific key. For example, the biometric data obtained at the first device may be encrypted using the content encryption key (CEK) to provide the user-specific key. Neither the biometric data nor the content encryption key (CEK) may be independently determined from the user-specific key. In addition, a rights encryption key (REK) may be used to encrypt the user-specific rights object prior to loading the user-specific rights object on the second device.

Likewise, in some embodiments, the biometric data obtained at the second device may be combined with the user-specific key to provide the content encryption key (CEK). For example, the biometric data obtained at the second device may be decrypted using the user-specific key to provide the content encryption key (CEK). In addition, where the user-specific rights object was encrypted at the first device, the user-specific rights object may be decrypted using the rights encryption key (REK) prior to combining the biometric data obtained from the second device therewith. The digital multimedia content may be decrypted using the content encryption key (CEK) to render the digital multimedia content on the second device.

In other embodiments, the rights object may be encrypted using a rights encryption key (REK) associated therewith, and the rights encryption key (REK) may be combined with the biometric data obtained at the first device to provide the user-specific rights object. For example, the biometric data obtained at the first device may be used to encrypt the rights encryption key (REK). Likewise, the biometric data obtained at the second device may be combined with the user-specific rights object to provide the rights encryption key (REK). For example, the biometric data obtained at the second device may be used to decrypt the rights encryption key (REK). The rights object may be decrypted using the retrieved rights encryption key (REK).

In some embodiments, the biometric user data obtained at the first and second devices may include fingerprint biometric data, palm print biometric data, optical biometric data, facial biometric data, voice biometric data, signature biometric data, and/or motion-based biometric data, such as keystroke biometric data.

In other embodiments, the biometric user data obtained at the first device may include biometric user data corresponding to first and second users, while the biometric user data obtained at the second device may include biometric user data from at least one of the first and second users. In other words, the biometric data obtained at the second device may correspond to the first user and/or the second user. The biometric data obtained at the second device may be combined with the user-specific rights object to provide the rights object if the biometric data obtained at the second device matches at least a portion of the biometric user data corresponding to the first user and/or the second user obtained at the first device. Accordingly, at least some use of the digital multimedia content on the second device may be prevented if the biometric data obtained at the second device does not match at least a portion of the biometric user data obtained at the first device.

In some embodiments, the biometric user data obtained at the first and/or second device may be respectively stored in the first and/or second device for later use. In other embodiments, at least one of the first and second devices may be a publicly-usable device.

According to other embodiments of the present invention, a digital rights management method includes encrypting a key associated with digital multimedia content using biometric user data to provide a user-specific key for the digital multimedia content. The user-specific key may be decrypted using the same biometric user data used for encryption to render the digital multimedia content. For example, encrypting may be performed at a first device responsive to obtaining the biometric data via a first biometric sensor associated with the first device, and decrypting may be performed at a second device responsive to obtaining the biometric data via a second biometric sensor associated with the second device.

According to further embodiments of the present invention, a system for sharing digital multimedia content having a rights object associated therewith between multiple devices includes a first device configured to be loaded with digital multimedia content and an associated rights object. The first device includes a first biometric sensor associated with the first device and a combination module coupled to the first biometric sensor. The first biometric sensor is configured to obtain first biometric user data. The combination module is configured to combine the first biometric data with the rights object to provide a user-specific rights object. The system further includes a second device configured to be loaded with the multimedia content and the user-specific rights object. The second device includes a second biometric sensor associated with the second device and a decombination module coupled to the second biometric sensor. The second biometric sensor is configured to obtain second biometric user data. The decombination module is configured to combine the second biometric data with the user-specific rights object to provide the rights object. For example, the decombination module may be configured to combine the second biometric data with the user-specific rights object if the second biometric data matches the first biometric data. The second device further includes a rendering module coupled to the decombination module and configured to render the digital multimedia content on the second device using the rights object. As such, the decombination module may be configured to prevent at least some use of the digital multimedia content on the second device if the second biometric data does not match the first biometric data.

In some embodiments, the combination module may be an encryption module that is configured to encrypt the rights object using the first biometric data to provide the user-specific rights object. Likewise, the decombination module may be a decryption module that is configured to decrypt the user-specific rights object using the second biometric data to provide the rights object.

In other embodiments, the rights object may include a content encryption key (CEK) used to encrypt the digital multimedia content. The combination module may be configured to combine the first biometric data with the content encryption key (CEK) to provide a user-specific key, and the decombination module may be configured to combine the second biometric data with the user-specific key to provide the content encryption key (CEK). The rendering module may be configured to decrypt the digital multimedia content using the content encryption key (CEK) to render the digital multimedia content on the second device.

According to still further embodiments of the present invention, a device for providing digital rights management of digital multimedia content stored therein includes a biometric sensor and an encryption module coupled to the biometric sensor. The biometric sensor is configured to obtain biometric user data. The encryption module is configured to encrypt a key associated with the digital multimedia content using the biometric user data to provide a user-specific key for the digital multimedia content. The device may further include a decryption module coupled to the biometric sensor and a rendering module coupled to the decryption module. The decryption module may be configured to decrypt the user-specific key using the biometric user data to obtain the key. The rendering module may be configured to render the digital multimedia content on the device using the key.

Although described above primarily with respect to method, system, and device aspects, it will be understood that the present invention may be embodied as methods, systems, electronic devices, and/or computer program products.

### BRIEF DESCRIPTION OF THE DRAWINGS

FIG. 1 is a block diagram illustrating exemplary systems for sharing DRM-protected multimedia content using biometric data according to some embodiments of the present invention.

FIG. 2 is a block diagram illustrating exemplary devices configured for sharing DRM-protected multimedia content using biometric data according to some embodiments of the present invention.

FIGS. 3-6 are flowcharts illustrating exemplary operations for sharing DRM-protected multimedia content using biometric data that may be performed according to some embodiments of the present invention.

### DETAILED DESCRIPTION OF EMBODIMENTS OF THE INVENTION

The present invention now will be described more fully hereinafter with reference to the accompanying drawings, in which illustrated embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. In contrast, when an element is referred to as being “directly coupled” or “directly connected” to another element, there are no intervening elements present. Furthermore, “connected” or “coupled” as used herein may include wirelessly connected or coupled. As used herein, the term “and/or” includes any and all combinations of one or more of the associated listed items, and may be abbreviated as “/”.

It will also be understood that, although the terms first, second, etc. may be used herein to describe various elements, these elements should not be limited by these terms. These terms are only used to distinguish one element from another. For example, a first multimedia device could be termed a second multimedia device, and, similarly, a second multimedia device could be termed a first multimedia device without departing from the teachings of the disclosure.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention may be embodied as methods, systems, and devices. Accordingly, the present invention may be embodied in hardware and/or in software (including firmware, resident software, micro-code, etc.). Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package. The program code may execute entirely on a multimedia device or only partly on the multimedia device and partly on another device. In the latter scenario, the other device may be connected to the multimedia device through a wired and/or wireless local area network (LAN) and/or wide area network (WAN), or the connection may be made to an external computer (for example, through the Internet using an Internet Service Provider).

The present invention is described below with reference to flowchart illustrations and/or block and/or flow diagrams of methods, systems, and devices according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks. It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

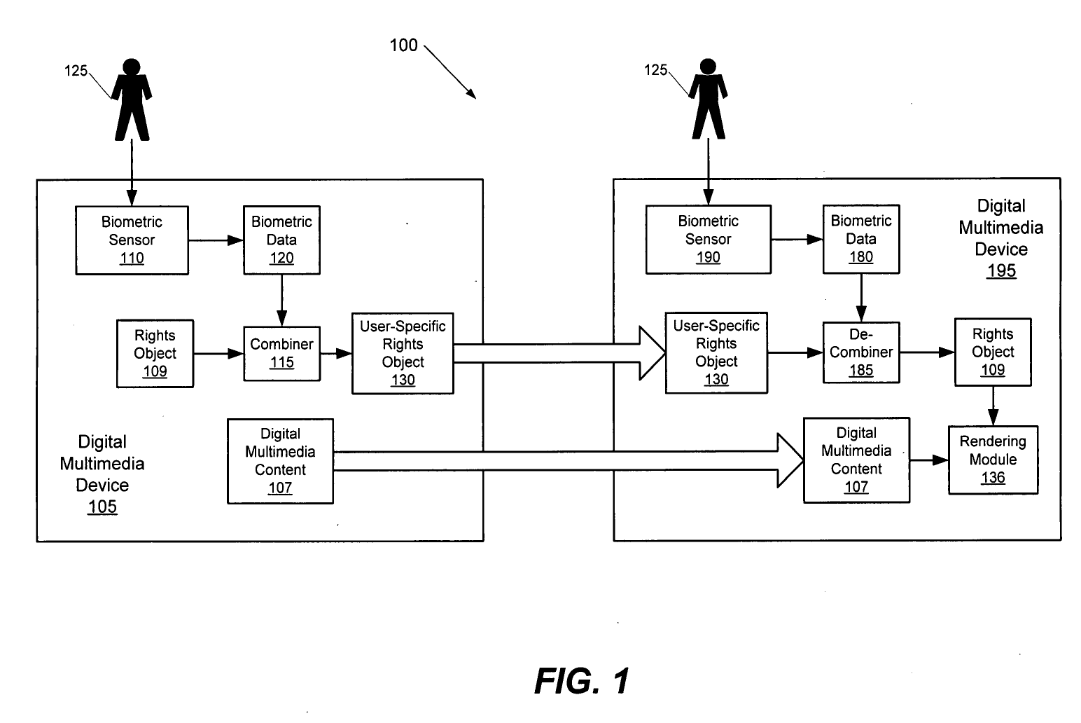

Some embodiments of the present invention provide for sharing of DRM-protected multimedia content among different devices that are associated with one or more individuals by using biometric data obtained from the one or more individuals. FIG. 1 illustrates an exemplary system 100 and methods for sharing DRM-protected multimedia content using biometric data according to some embodiments of the present invention. Referring now to FIG. 1, the system 100 includes a first digital multimedia device 105 and a second digital multimedia device 195 that are associated with a user 125. The digital multimedia devices 105 and 195 may be, for example, laptop computers, notebook computers, handheld computers, personal communication system terminals, personal digital assistants (PDA), pagers, portable music players, and/or radiotelephones; however, the digital multimedia devices 105 and 195 need not be identical. For example, the first digital multimedia device 105 may be a personal computer owned by the user 125, and the second digital multimedia device 195 may be a portable music player, such as an MP3 player, owned by the user 125. Alternatively, the digital multimedia device 105 and the digital multimedia device 195 may be of a same type. Moreover, one or more of the first and second digital multimedia devices 105 and 195 may be a publicly-usable device that is being accessed by the user 125. Also, at least one of the digital multimedia devices 105 and 195 may be capable of purchasing and/or acquiring digital multimedia content, for example, from a content provider.

Still referring to FIG. 1, the digital multimedia device 105 includes digital multimedia content 107 and an associated rights object 109. The digital multimedia content 107 may include digital audio, digital video and/or digital images which may be embodied in digital multimedia products. The rights object 109 contains the obligations, permissions, and/or constraints for the use of the digital multimedia content 107. For example, where the digital multimedia content 107 is a song, the rights object 109 may specify that the song may only be played a predetermined number of times without payment, and may be configured to count usage of the song and prevent use of the song after the predetermined number of plays. As such, the rights object 109 may include a content encryption key (CEK) which may be used to secure the digital multimedia content 107. The rights object 109 itself may also be protected by encryption, for example, using a right encryption key (REK). Accordingly, the rights object 109 can be secured, stored, and/or obtained separately from the digital multimedia content 107. For example, where the digital multimedia content 107 is obtained from a content provider, the rights object 109 may be obtained from a rights issuer separate from the content provider.

The digital multimedia device 105 further includes a biometric sensor 110 and a combiner/combination module 115. The biometric sensor 110 is configured to obtain biometric data 120 from the user 125. As used herein, biometric data may refer to any data corresponding to a physical feature and/or a repeatable action associated with an individual. For example, biometric data may include voice data, fingerprint data, palm print data, optical data, facial data, data relating to a user's signature, and/or motion-based data, such as data relating to a user's typing keystroke and/or other movements. As such, the biometric data 120 may be a biometric value that is unique to the user 125. The combination module 115 is coupled to the biometric sensor 110 and is configured to combine the biometric user data 120 with the rights object 109 to provide a user specific rights object 130. For example, the biometric user data 120 may be combined with the rights object 109 by appending and/or interspersing the biometric user data 120 into the rights object 109. Alternatively, the biometric data 120 and the rights object 109 may be multiplied and/or multiplexed, for example, in a manner similar to code spreading in a CDMA communications system. In addition, the combination module 115 may be an encryption module that is configured to encrypt the rights object 109 using the biometric user data 120. Accordingly, as used herein, the terms ‘combination’ and/or ‘combine’ include all manners of obtaining a user-specific rights object from a rights object and biometric user data. As such, the user specific rights object 130 may be a secure block of data that may be stored and/or transferred independently of the digital multimedia content 107.

As shown in FIG. 1, the digital multimedia content 107 and the user specific rights object 130 may be loaded onto the second digital multimedia device 195. The second digital multimedia device 195 includes a biometric sensor 190. The biometric sensor 190 is configured to obtain biometric data 180 from the user 125. The biometric sensor 190 may be similar to the biometric sensor 110 of the first digital multimedia device 105. For example, where the biometric sensor 110 is a fingerprint scanner, the biometric sensor 190 may also be a fingerprint scanner. As such, the biometric data 180 obtained from the biometric sensor 190 may match the biometric data 120 obtained from the biometric sensor 110 where a common user 125 is present. In other words, where the biometric sensor 190 and the biometric sensor 110 are configured to sense similar biometric data, each may produce the same unique biometric value for the user 125.

The second digital multimedia device 195 further includes a decombiner/decombination module 185. The decombination module 185 is configured to combine the obtained biometric user data 180 with the user specific rights object 130 to provide the rights object 109 on the second digital multimedia device 195. More specifically, the decombination module 185 may be configured to provide the rights object 109 if the biometric user data 180 obtained at the second digital multimedia device 195 matches the biometric user data 120 obtained at the first digital multimedia device 105. For example, where the user specific rights object 130 was encrypted at the first digital multimedia device 105 using the biometric user data 120, the decombination module 185 may be a decryption module that is configured to decrypt the user specific rights object 130 using matching biometric user data 180 obtained at the second digital multimedia device 195. It will be understood that, as used herein, the terms ‘decombination’ and/or ‘decombine’ include all manners of obtaining a rights object from a user-specific rights object and biometric user data. As such, the decombination module 185 is configured to prevent at least some use of the digital multimedia content 107 on the second digital multimedia device 195 if the biometric user data 180 does not match the biometric user data 120.

The second digital multimedia device 195 further includes a rendering module 136 that is coupled to the decombination module 185 and is configured to render the digital multimedia content 107 on the second digital multimedia device 195 using the rights object 109 retrieved from the user-specific rights object 130. The biometric data 120 and 180 may also be respectively stored in the digital multimedia devices 105 and 195 for later use and/or access.

Additional description of the operation of the system 100 of FIG. 1 according to some embodiments of the present invention will now be provided. Referring again to FIG. 1, the rights object 109 stored on the first digital multimedia device 105 may include a content encryption key (CEK) that was used to encrypt the digital multimedia content 107. The combination module 115 may be configured to combine the biometric user data 120 with the CEK to provide a user-specific key, which may be included in the user-specific rights object 130. For example, the combination module 115 may be an encryption module configured to encrypt the CEK using the biometric user data 120. As such, the biometric data 120 acquired at the first digital multimedia device 105 may bind the rights object 109 to the particular user 125. In some embodiments, the user-specific rights object 130 may be further secured at the first multimedia device 105 using a rights encryption key (REK).

Upon transfer of the digital multimedia content 107 and the user-specific rights object 130 to the second digital multimedia device 195, the decombination module 185 may be configured to combine the biometric user data 180 with the user-specific key (included in the user-specific rights object 130) to provide the rights object 109, including the CEK, on the second digital multimedia device 195. For example, the decombination module 185 may be a decryption module configured to decrypt the user-specific key using the biometric user data 180 to provide the CEK. If the user-specific rights object 130 was encrypted at the first multimedia device 105, it may be decrypted at the second multimedia device 195 using the REK prior to combination with the biometric user data 180. The rendering module may then use the CEK to decrypt and render the digital multimedia content 107 on the second digital multimedia device 195.

Although FIG. 1 illustrates exemplary systems/methods for sharing DRM-protected content according to some embodiments of the present invention, it will be understood that the present invention is not limited to such configuration, but is intended to encompass any configuration capable of carrying out the operations described herein. For example, although the biometric sensors 110 and 190 are illustrated as being included in the first and second digital multimedia devices 105 and 195, respectively, the biometric sensors 110 and 190 may be separate from and/or otherwise associated with the first and second digital multimedia devices 105 and 195. In addition, although only a single user 125 is illustrated in FIG. 1, the biometric user data 120 may represent biometric data from multiple users. For example, a husband and wife who jointly own the digital multimedia device 105 may each provide biometric data via the biometric sensor 110. As such, the user specific rights object 130 that is created from the biometric data 120 and the rights object 109 may correspond to first and second users. However, biometric data from only one of the users may be required to provide the rights object 109 on the second digital multimedia device 195. For instance, in the above example, the wife may wish to use the digital multimedia content 107 on the second multimedia device 195 when the husband is not present. As such, the biometric user data 180 obtained from the biometric sensor 190 of the second digital multimedia device 195 may correspond to either the husband or the wife. Thus, the biometric user data 180 may be combined with the user-specific rights object 130 if the biometric user data 180 matches at least a portion of the biometric user data 120 corresponding to either the first user or the second user.

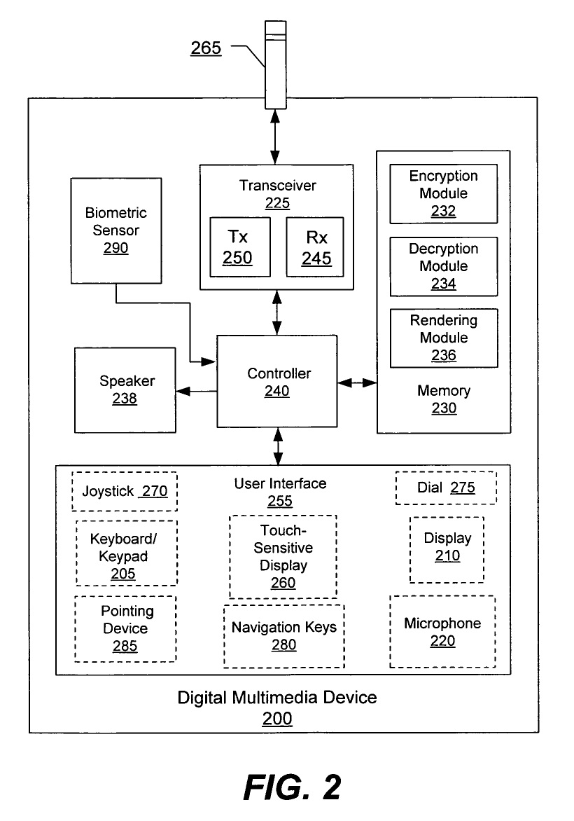

FIG. 2 is a block diagram illustrating a digital multimedia device 200 configured for sharing DRM-protected multimedia content according to some embodiments of the present invention. The digital multimedia device 200 may correspond to one of the digital multimedia devices 105 and 195 of the system of FIG. 1. As shown in FIG. 2, the digital multimedia device 200 includes a transceiver 225, an antenna 265, a controller 240, memory 230, a speaker 238, a biometric sensor 290 and a user interface 255. The user interface 255 may include a microphone 220, a display 210 (such as a liquid crystal display), a joystick 270, a keypad 205, a touch sensitive display 260, a dial 275, navigation keys 280, and/or a pointing device 285 (such as a mouse, trackball, touchpad, etc.), depending on the functionalities of the digital multimedia device 200. As such, additional and/or fewer elements of the user interface 255 may actually be provided. For example, the touch sensitive display 260 may be provided in a PDA that does not include a display 210, a keypad 205, and/or pointing device 285.

The transceiver 225 typically includes a transmitter circuit 250 and a receiver circuit 245, which cooperate to transmit and receive radio frequency signals via the antenna 265. The radio frequency signals may include both traffic and control signals (e.g., paging signals/messages for incoming calls), which are used to establish and maintain communication with another party or destination. The radio frequency signals may also include packet data information, such as, for example, general packet radio system (GPRS) information. In addition, the transceiver 225 may include an infrared (IR) transceiver configured to transmit and/or receive infrared signals to/from other electronic devices via an IR port, and/or may include a Bluetooth (BT) transceiver.

Still referring to FIG. 2, the controller 240 is coupled to the transceiver 225, the memory 230, the speaker 238, the biometric sensor 290, and the user interface 255. The controller may be, for example, a commercially available or custom microprocessor that is configured to coordinate and manage operations of the transceiver 225, the memory 230, the speaker 238, the biometric sensor 290, and/or the user interface 255. The memory 230 may represent a hierarchy of memory that may include volatile and/or nonvolatile memory, such as removable flash, magnetic, and/or optical rewritable nonvolatile memory. As shown in FIG. 2, the memory 230 may also include an encryption module 232, a decryption module 234, and a rendering module 236. Although not shown, the memory 230 may also be configured to store digital multimedia content and a rights object (including a key) associated with the digital multimedia content.

The biometric sensor 290 may be configured to obtain biometric user data, for example, from a user, such as the user 125 of FIG. 1. The encryption module 232 may be configured to encrypt the key associated with the digital multimedia content using the biometric user data to provide a user-specific key for the digital multimedia content. The decryption module 234 may be configured to decrypt the user-specific key using the biometric user data obtained from the biometric sensor 290 to retrieve the original key included in the rights object. For example, the decryption module 234 may be configured to successfully decrypt the user-specific key only if the biometric user data obtained from the biometric sensor 290 matches the biometric user data used to encrypt the user-specific key. In other words, the decryption module 234 may be configured such that decryption may fail if the biometric user data obtained from the biometric sensor 290 does not match the biometric user data used to encrypt the user-specific key. The rendering module 236 may be configured to render the digital multimedia content on the digital multimedia device 200 using the retrieved key. As such, the digital multimedia content may be protected such that only the user(s) who provided the biometric data used to encrypt the key can access the content.

Accordingly, digital multimedia content may be securely transferred from the digital multimedia device 200 to another device by using biometric user data received via the biometric sensor 290. In particular, the key associated with the digital multimedia content may be encrypted using the biometric user data by the encryption module 232 at the digital multimedia device 200, and may then be securely loaded onto another device. In addition, digital multimedia content may be received at the digital multimedia device 200 from another device, and may be successfully rendered at the digital multimedia device 200 by using biometric data received from a user via the biometric sensor 290. More specifically, the key associated with the content may be decrypted using the biometric user data by the decryption module 234, and the digital multimedia content may be rendered on the digital multimedia device 200 via the rendering module 236. However, if the biometric user data obtained from the biometric sensor 290 does not match the biometric user data used to encrypt the key, decryption may fail. As such, digital multimedia content can be transferred between devices associated with a user, but cannot be rendered (or, in some embodiments, cannot be fully rendered) on the devices without access to the biometric data associated with that particular user.

Although FIG. 2 illustrates an exemplary digital multimedia device that may be used for sharing DRM-protected multimedia content, it will be understood that the present invention is not limited to such a configuration but is intended to encompass any configuration capable of carrying out the operations described herein. For example, although the memory 230 is illustrated as separate from the controller 240, the memory 230 or portions thereof may be considered as a part of the controller 240. Moreover, although illustrated as part of the memory 230, the encryption module 232, the decryption module 234, and/or the rendering module 236 may be separate entities. Also, the functions of the encryption module 232, the decryption module 234, and/or the rendering module 236 may be performed by the controller 240. More generally, while particular functionalities are shown in particular blocks by way of illustration, functionalities of different blocks and/or portions thereof may be combined, divided, and/or eliminated.

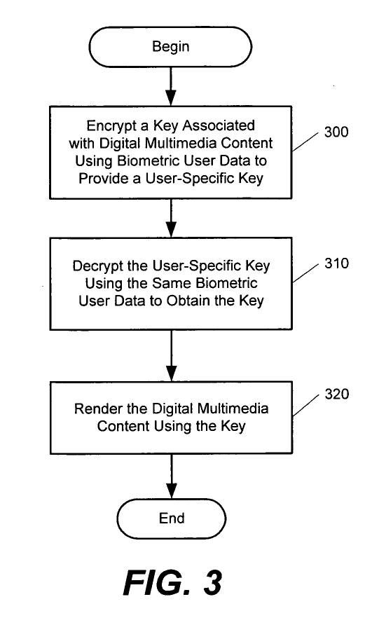

FIG. 3 is a flowchart illustrating exemplary operations for providing digital rights management according to some embodiments of the present invention. For example, the operations illustrated in FIG. 3 may be performed by a digital multimedia device, such as the digital multimedia device 200 of FIG. 2. Referring now to FIG. 3, operations begin (Block 300) when a key associated with digital multimedia content is encrypted using biometric user data to provide a user-specific key. The biometric user data may be provided, for example, by a biometric sensor, such as the biometric sensor 290 of FIG. 2. Thus, a secure user-specific key is generated, which can be stored and/or transferred between multiple devices. The user-specific key is decrypted using the biometric user data to obtain the key (Block 310). For example, the key may be encrypted using biometric user data associated with a particular user obtained at a first digital multimedia device, and may be decrypted using biometric user data associated with that particular user obtained at a second digital multimedia device, for example, via a second biometric sensor associated with the second digital multimedia device. Accordingly, at least some use of the digital multimedia content may be prevented, as the user-specific key may not be decrypted unless biometric user data is provided that matches the biometric user data used to encrypt the key. The digital multimedia content is then rendered using the key (Block 320).

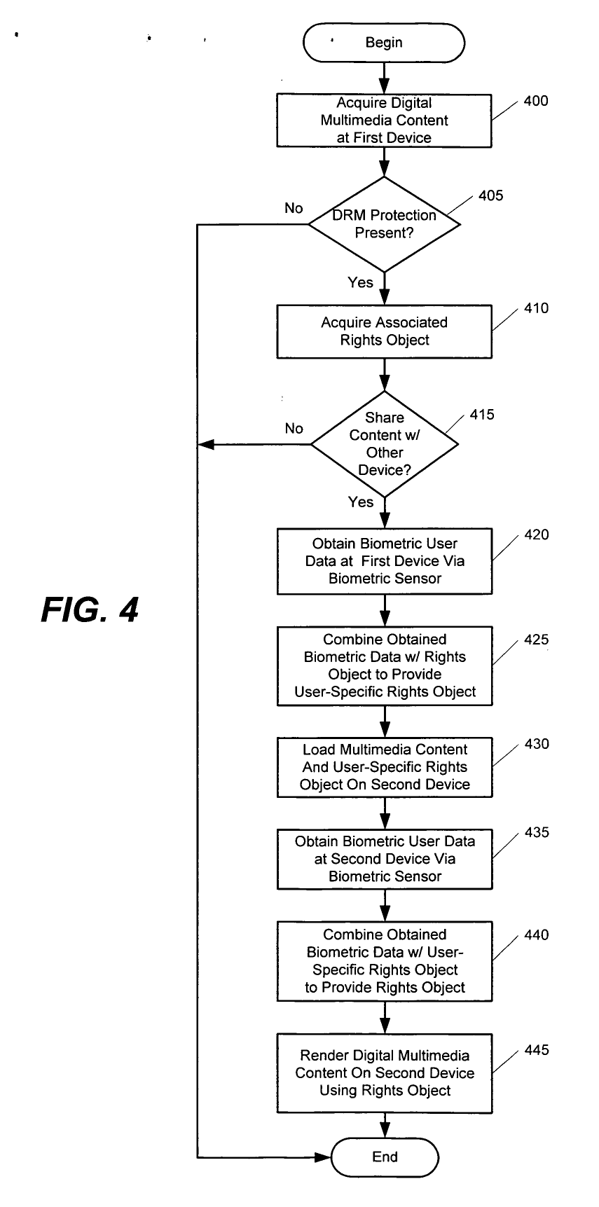

FIG. 4 is a flowchart illustrating exemplary operations for sharing DRM-protected multimedia content using biometric data according to other embodiments of the present invention. For example, the exemplary operations described in FIG. 4 may be performed by a system configured for sharing DRM-protected content, such as the system 100 of FIG. 1. Referring now to FIG. 4, operations begin (Block 400) when digital multimedia content is acquired at a first device, such as the first digital multimedia device 105 of FIG. 1. For example, the first device may be a laptop computer, and the digital multimedia content may be downloaded from the internet, from a CD/DVD, and/or from any other entity that is authorized to distribute digital multimedia content, hereinafter referred to as a content issuer. If it is determined that the acquired digital multimedia content is protected by digital rights management (DRM) technology (Block 405), a rights object associated with the digital multimedia content is acquired (Block 410). For example, the rights object may be acquired from the content issuer who provided the digital multimedia content, or from a separate entity that is authorized to distribute the rights object, hereinafter referred to as a rights issuer.

Still referring to FIG. 4, if a user desires to share the digital multimedia content with another device (Block 415), biometric data is obtained from the user at the first device via a biometric sensor associated with the first device (Block 420). For example, the biometric data may be voice data, fingerprint data, palm print data, optical data, facial data, data relating to the user's signature, and/or motion-based data, such as data related to the user's keystrokes when typing or other movements. The obtained biometric user data is combined with the rights object to provide a user-specific rights object (Block 425). For example, the rights object may be encrypted using the biometric user data to provide the user-specific rights object. In addition, the user-specific rights object may be further encrypted, for example, using a rights encryption key (REK), at the first device.

The digital multimedia content and the user-specific rights object are then loaded onto a second device, such as the second digital multimedia device 195 of FIG. 1. (Block 430). For example, the second device may be a MP3 player to which the user wishes to transfer digital multimedia content from his laptop computer. However, as the user-specific rights object may be cryptographically bound to the user who provided the biometric user data, the digital multimedia content and the user-specific rights object can be forwarded to other devices, but cannot be rendered and/or fully rendered by these devices unless they same type of biometric data from the same user is acquired at the devices. As such, biometric data of the same type is obtained from the user at the second device via a biometric sensor associated with the second device (Block 435). For example, if optical biometric data was obtained from the user at the first device, optical biometric data is also obtained from the user at the second device. The biometric data obtained at the second device is then combined with the user-specific rights object to provide the rights object (Block 440). For example, the user-specific rights object may be decrypted using the biometric data obtained at the second device to provide the rights object. The biometric data may be combined with the user-specific rights object to retrieve the rights object only if the biometric data obtained at the second device matches the biometric data obtained at the first device. If the user specific rights object was also encrypted using a rights encryption key (REK), the REK may be used to decrypt the user-specific rights object prior to combining the user-specific rights object with the biometric data obtained at the second device. The digital multimedia content is then rendered on the second device using the rights object (Block 445). As such, at least some use of the digital multimedia content is prevented on the second device if the biometric data obtained at the second device does not match the biometric data obtained at the first device.

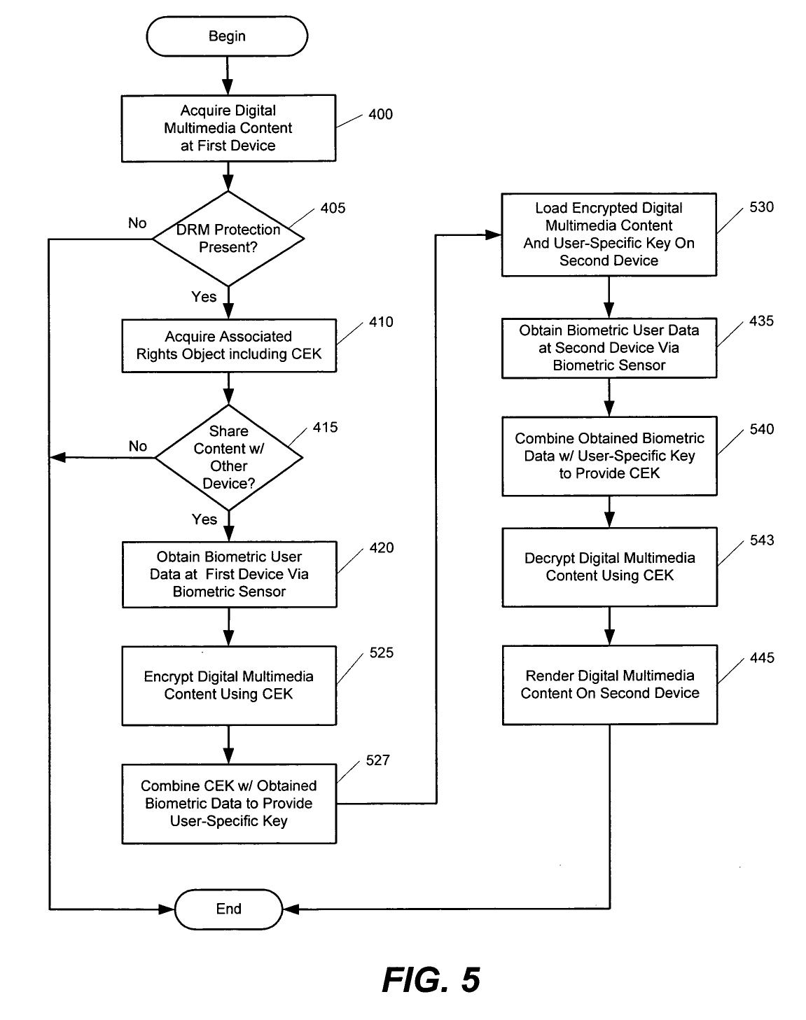

FIG. 5 is a flowchart illustrating exemplary operations for sharing DRM-protected content among multiple devices according to further embodiments of the present invention. As illustrated in FIG. 5, after acquiring the digital multimedia content (Block 400) and determining that DRM protection is present (Block 405), a rights object associated with the digital multimedia content and including a content encryption key (CEK) is acquired (Block 410). Upon deciding to share the digital multimedia content with another device (Block 415) and after obtaining biometric user data from the user at the first device (Block 420), the digital multimedia content is encrypted using the content encryption key (Block 525). The biometric data obtained at the first device is combined with the content encryption key to provide a user-specific key (Block 527). For example, the content encryption key may be encrypted using the biometric data obtained at the first device to provide the user-specific key. As such, neither the biometric data nor the content encryption key may be determined independently from the user-specific key. The encrypted digital multimedia content and the user-specific key are then loaded onto a second device (Block 530). After obtaining biometric user data at the second device (Block 435), the user-specific key is combined with the biometric data obtained at the second device to provide the content encryption key (Block 540). For example, the user-specific key may be decrypted using the biometric data obtained at the second device to provide the content-encryption key. The digital multimedia content may then be decrypted on the second device using the content encryption key (Block 543). Accordingly, the digital multimedia content may be rendered on the second device (Block 445) as described above.

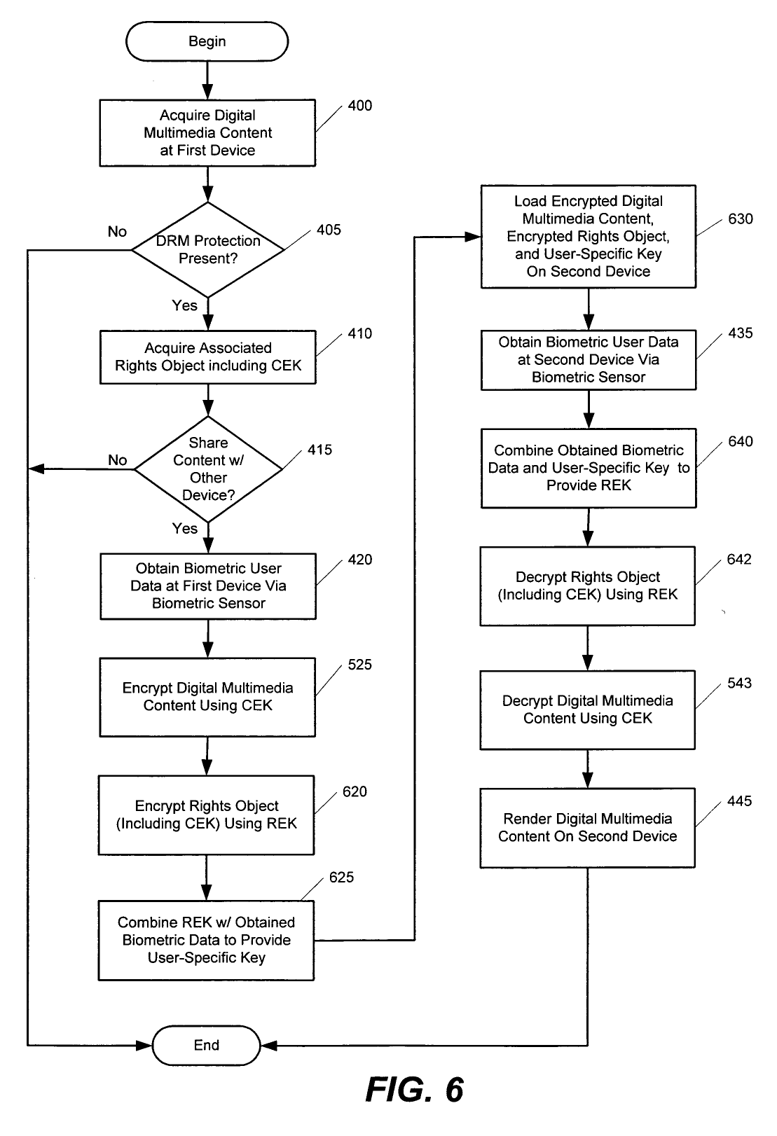

FIG. 6 is a flowchart illustrating exemplary operations for sharing DRM-protected multimedia content according to still further embodiments of the present invention. As shown in FIG. 6, digital multimedia content is acquired (Block 400), the presence of DRM protection is determined (Block 405), and a rights object including a content encryption key acquired (Block 410). After encrypting the digital multimedia content using the content encryption key (Block 525), the rights object is encrypted using a rights encryption key (REK) associated with the rights object (Block 620). The rights encryption key is then combined with the biometric data obtained at the first device (Block 625) to provide a user-specific key. For example, the rights encryption key may be encrypted using the biometric data obtained at the first device to provide the user-specific key. The encrypted multimedia content, the encrypted rights object, and the user-specific key are then loaded onto the second device (Block 630), and biometric user data is obtained at the second device (Block 435). The biometric data obtained at the second device is combined with the user-specific key to provide the rights encryption key (Block 640). For example, the user-specific key may be decrypted to provide the rights encryption key using the biometric data obtained at the second device if the biometric data obtained at the second device matches the biometric data obtained at the first device. The rights object, including the content encryption key, is decrypted using the retrieved rights encryption key (Block 642). The decrypted content encryption key is used to decrypt the digital multimedia content (Block 543), and the digital multimedia content is rendered on the second device (Block 445), as described in detail above.

Thus, according to some embodiments of the present invention, biometric data may be used to create a “key” that can securely provide for sharing of DRM-protected multimedia content among multiple devices associated with a user. More specifically, the digital multimedia content may be secured based on voice, fingerprint, handprint, facial, optical, signature, motion (such as keystroke and/or other movement), and/or other biometric data that is unique to a particular user.

As such, the user may freely and securely transfer the digital multimedia content among multiple devices, while other users may be prevented from at least some use of the digital multimedia content.

In the drawings/specification, there have been disclosed exemplary embodiments of the invention. However, many variations and modifications can be made to these embodiments without substantially departing from the principles of the present invention. Accordingly, although specific terms are used, they are used in a generic and descriptive sense only and not for purposes of limitation, the scope of the invention being defined by the following claims.

That which is claimed:

1. A method of sharing digital multimedia content having a rights object associated therewith between multiple devices, the method comprising:
obtaining biometric user data at a first device via a biometric sensor associated therewith, the first device including digital multimedia content and an associated rights object therein;
combining the biometric user data obtained at the first device with the rights object to provide a user-specific rights object;
loading the multimedia content and the user-specific rights object on a second device;
obtaining biometric user data at the second device via a biometric sensor associated therewith;
combining the biometric user data obtained at the second device with the user-specific rights object to provide the rights object; and
rendering the digital multimedia content on the second device using the rights object.

2. The method of claim 1, wherein combining the biometric user data obtained at the first device with the rights object comprises:
encrypting the rights object using the biometric user data obtained at the first device to provide the user-specific rights object.

3. The method of claim 2, wherein combining the biometric user data obtained at the second device with the user-specific rights object comprises:
decrypting the user-specific rights object using the biometric user data obtained at the second device to provide the rights object.

4. The method of claim 1, further comprising:
preventing at least some use of the digital multimedia content on the second device if the biometric user data obtained at the second device does not match the biometric user data obtained at the first device.

5. The method of claim 1, wherein the rights object includes a content encryption key (CEK) used to encrypt the digital multimedia content, and wherein combining the biometric user data obtained at the first device with the rights object comprises:
combining the biometric user data obtained at the first device with the content encryption key (CEK) to provide a user-specific key.

6. The method of claim 5, wherein combining the biometric user data obtained at the first device with the content encryption key (CEK) comprises:
encrypting the content encryption key (CEK) using the biometric user data obtained at the first device to provide the user-specific key.

7. The method of claim 5, wherein combining the biometric user data obtained at the second device with the user-specific rights object comprises:
combining the biometric user data obtained at the second device with the user-specific key to provide the content encryption key (CEK),
and wherein rendering the digital multimedia content comprises decrypting the digital multimedia content using the content encryption key (CEK) to render the digital multimedia content on the second device.

8. The method of claim 7, wherein combining the biometric user data obtained at the second device with the user-specific key comprises:
decrypting the user-specific key using the biometric user data obtained at the second device to provide the content encryption key (CEK).

9. The method of claim 1, wherein the rights object includes a content encryption key (CEK) used to encrypt the digital multimedia content, and wherein combining the biometric user data obtained at the first device with the rights object to provide a user-specific rights object comprises:
encrypting the rights object using a rights encryption key (REK) associated therewith; and
combining the rights encryption key (REK) with the biometric user data obtained at the first device.

10. The method of claim 9, wherein combining the rights encryption key (REK) with the biometric user data obtained at the first device comprises:
encrypting the rights encryption key (REK) using the biometric user data obtained at the first device.

11. The method of claim 9, wherein combining the biometric user data obtained at the second device with the user-specific rights object comprises:
combining the biometric user data obtained at the second device with the user-specific rights object to provide the rights encryption key (REK); and
decrypting the rights object using the rights encryption key (REK).

12. The method of claim 11, wherein combining the biometric user data obtained at the second device with the user-specific rights object comprises:
decrypting the rights encryption key (REK) using the biometric user data obtained at the second device.

13. The method of claim 1, wherein the biometric user data obtained at the first and second devices comprises fingerprint biometric data, palm print biometric data, optical biometric data, facial biometric data, voice biometric data, signature biometric data, keystroke biometric data and/or other motion-based biometric data.

14. The method of claim 1, wherein the biometric user data obtained at the first device comprises biometric user data corresponding to first and second users, and wherein the biometric user data obtained at the second device comprises biometric user data from at least one of the first and second users, and further comprising:
preventing at least some use of the digital multimedia content on the second device if the biometric user data obtained at the second device does not match at least a portion of the biometric user data corresponding to the first user and/or the second user obtained at the first device.

15. The method of claim 1, further comprising:
respectively storing the biometric user data obtained at the first and/or second device in the first and/or second device.

16. The method of claim 1, wherein at least one of the first and second devices comprises a publicly-usable device.

17. A computer program product for sharing digital multimedia content having a rights object associated therewith between multiple devices, the computer program product comprising a computer readable storage medium having computer readable program code embodied therein configured to carry out the method of claim 1.

18. A digital rights management method, comprising:
encrypting a key associated with digital multimedia content using biometric user data to provide a user-specific key for the digital multimedia content.

19. The method of claim 18, further comprising:
decrypting the user-specific key using the biometric user data to render the digital multimedia content.

20. A computer program product for digital rights management, the computer program product comprising a computer readable storage medium having computer readable program code embodied therein configured to carry out the method of claim 18.

21. A system for sharing digital multimedia content having a rights object associated therewith between multiple devices, comprising:
a first device configured to be loaded with digital multimedia content and an associated rights object, the first device comprising:
a first biometric sensor configured to obtain first biometric user data;
a combination module coupled to the first biometric sensor and configured to combine the first biometric user data with the rights object to provide a user-specific rights object; and
a second device configured to be loaded with the multimedia content and the user-specific rights object, the second device comprising:
a second biometric sensor configured to obtain second biometric user data;
a decombination module coupled to the second biometric sensor and configured to combine the second biometric user data with the user-specific rights object to provide the rights object; and
a rendering module coupled to the decryption module and configured to render the digital multimedia content on the second device using the rights object.

22. The system of claim 21, wherein the decombination module is further configured to prevent at least some use of the digital multimedia content on the second device if the second biometric user data does not match the first biometric user data.

23. The system of claim 21, wherein the combination module comprises an encryption module that is configured to encrypt the rights object using the first biometric user data to provide the user-specific rights object.

24. The system of claim 21, wherein the decombination module comprises a decryption module that is configured to decrypt the user-specific rights object using the second biometric user data to provide the rights object.

25. The system of claim 21, wherein the rights object includes a content encryption key (CEK) used to encrypt the digital multimedia content, wherein the combination module is configured to combine the first biometric user data with the content encryption key (CEK) to provide a user-specific key, wherein the decombination module is configured to combine the second biometric user data with the user-specific key to provide the content encryption key (CEK), and wherein the rendering module is configured to decrypt the digital multimedia content using the content encryption key (CEK) to render the digital multimedia content on the second device.

26. A device for providing digital rights management for digital multimedia content stored therein, comprising:
a biometric sensor configured to obtain biometric user data; and
an encryption module coupled to the biometric sensor and configured to encrypt a key associated with the digital multimedia content using the biometric user data to provide a user-specific key for the digital multimedia content.

27. The device of claim 26, further comprising:
a decryption module coupled to the biometric sensor and configured to decrypt the user-specific key using the biometric user data to obtain the key; and
a rendering module coupled to the decryption module and configured to render the digital multimedia content on the device using the key.
